(19) United States
(12) Patent Application Publication
(10) Pub. No.: US 2018/0168345 A1
(43) Pub. Date: Jun. 21, 2018

(54) RESISTANCE-WELDING TYPE STORAGE RACK LAYER PLATE

(71) Applicant: Guohua CAO, Guangdong (CN)

(72) Inventor: Guohua CAO, Guangdong (CN)

(21) Appl. No.: 15/586,278

(22) Filed: May 4, 2017

(30) Foreign Application Priority Data
Dec. 20, 2016 (CN) 201621404022.5

(51) Int. Cl. A47B 96/02; A47B 55/02; B23K 11/00

(52) U.S. Cl. CPC A47B 96/021; B23K 11/002; A47B 55/02

(57) ABSTRACT

A resistance-welding type storage rack layer plate having a first taper sleeve (1), a second taper sleeve (2), a third taper sleeve (3), a fourth taper sleeve (4), a first frame assembly (5), a second frame assembly (6), a third frame assembly (7) and a fourth frame assembly (8); a fitting and welding part (11) is respectively arranged on the two ends of a first metal connecting rod (9) and a second metal connecting rod (10) of each frame assembly, the fitting and welding part (11) is bended inwards, and the inner side surface of the fitting and welding part (11) fits with and is connected with the outer walls of the first taper sleeve (1), the second taper sleeve (2), the third taper sleeve (3) and the fourth taper sleeve (4). The fitting and welding part (11) also may be designed to be bended outwards.

### BACKGROUND OF THE INVENTION

The disclosure relates to the technical field of storage racks, and more specifically to a resistance-welding type storage rack layer plate.

In daily lives, people often place objects on a storage rack. Traditional storage rack layer plates of storage racks are composed of a frame assembly, a sleeve pipe connected with the frame assembly and a storage plate connected with the frame assembly, wherein a connecting rod of the frame assembly is a straight rod, the two ends of the straight rod of the frame assembly and the sleeve pipe are processed by shielded welding (that is, adopting welding wires and carbon dioxide to conduct welding) so that the frame assembly is integrally connected with the sleeve pipe, however, the connecting rod of the frame assembly of this structure cannot connect the frame assembly with the sleeve pipe by resistance welding. Moreover, welding wires or carbon dioxide are needed to conduct welding, the welding cost is high, and the carbon dioxide is a greenhouse gas, which will cause pollution to environment and is not environment friendly.

### BRIEF SUMMARY OF THE INVENTION

The object of the disclosure is to overcome the above defects in existing technologies and provide a resistance-welding type storage rack layer plate, which is welded without using welding wires or carbon dioxide, is convenient to weld and low in welding cost and is beneficial for environment protection.

In order to realize the above object, the disclosure provides a technical scheme as follows.

A resistance-welding type storage rack layer plate includes a first taper sleeve, a second taper sleeve, a third taper sleeve, a fourth taper sleeve, a first frame assembly, a second frame assembly, a third frame assembly and a fourth frame assembly; the first frame assembly, the second frame assembly, the third frame assembly and the fourth frame assembly include a first metal connecting rod and a second metal connecting rod; the two ends of the first metal connecting rod and the second metal connecting rod are respectively provided with a fitting and welding part, adjacent ends of the first frame assembly and the second frame assembly fit with the outer wall of the first taper sleeve through the fitting and welding part and the fitting and welding part is integrally connected with the first taper sleeve by resistance welding, adjacent ends of the second frame assembly and the third frame assembly fit with the outer wall of the second taper sleeve through the fitting and welding part and the fitting and welding part is integrally connected with the second taper sleeve by resistance welding, adjacent ends of the third frame assembly and the fourth frame assembly fit with the outer wall of the third taper sleeve through the fitting and welding part and the fitting and welding part is integrally connected with the third taper sleeve by resistance welding, adjacent ends of the first frame assembly and the fourth frame assembly fit with the outer wall of the fourth taper sleeve through the fitting and welding part and the fitting and welding part is integrally connected with the fourth taper sleeve by resistance welding; the resistance-welding type storage rack layer plate further includes a storage plate integrally connected with the first frame assembly, the second frame assembly, the third frame assembly and the fourth frame assembly.

As a preferred embodiment, the fitting and welding part is bended inwards, and the inner side surface of the fitting and welding part fits with and, by resistance welding, is integrally connected with the outer walls of the first taper sleeve, the second taper sleeve, the third taper sleeve and the fourth taper sleeve.

As a preferred embodiment, the fitting and welding part is bended outwards, and the inner side surface of the fitting and welding part fits with and, by resistance welding, is integrally connected with the outer walls of the first taper sleeve, the second taper sleeve, the third taper sleeve and the fourth taper sleeve.

Compared with existing technologies, the disclosure has benefits as follows:

The disclosure arranges a fitting and welding part on both ends of the first metal connecting rod and the second metal connecting rod of each frame assembly; the fitting and welding part is bended inwards, and the inner side surface of the fitting and welding part fits with and, by resistance welding, is integrally connected with the outer walls of the first taper sleeve, the second taper sleeve, the third taper sleeve and the fourth taper sleeve. The fitting and welding part also may be designed to be bended outwards, and the inner side surface of the fitting and welding part fits with and, by resistance welding, is integrally connected with the outer walls of the first taper sleeve, the second taper sleeve, the third taper sleeve and the fourth taper sleeve. The resistance-welding type storage rack layer plate is welded without using welding wires or carbon dioxide, is convenient to weld and low in welding cost and is beneficial for environment protection.

### BRIEF DESCRIPTION OF THE DRAWINGS

To more clearly describe the technical scheme in the embodiment of the disclosure or in existing technologies, drawings needed in the description of the embodiment or existing technologies are simply illustrated below; obviously, drawings described below are some embodiments of the disclosure; for the ordinary staff in the field, other drawings may be obtained according to these drawings without creative work.

FIG. 1 is a stereoscopic structure diagram of an Embodiment 1 of a resistance-welding type storage rack layer plate of the disclosure.

FIG. 2 is a local enlarged view of FIG. 1.

FIG. 3 is a stereoscopic structure diagram of an Embodiment 2 of a resistance-welding type storage rack layer plate of the disclosure.

FIG. 4 is a local enlarged view of FIG. 3.

### DETAILED DESCRIPTION OF THE INVENTION

To make the object, technical scheme and advantages of the embodiment of the disclosure more clear, a clear and complete description as below is provided to the technical scheme in the embodiment of the disclosure in combination with the drawings in the embodiment of the disclosure. Obviously, the embodiments described hereinafter are simply part embodiments of the disclosure, but all the embodiments. Based on the embodiment of the disclosure, all other embodiments obtained by those skilled in the art without creative work are intended to be included in the scope of protection of the disclosure.

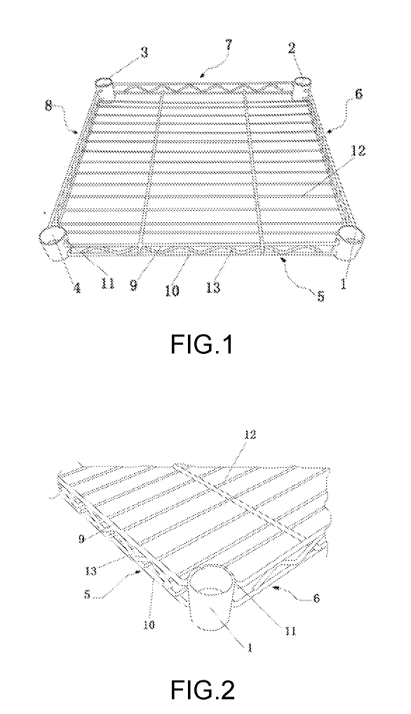

Embodiment 1, please refer to FIG. 1 and FIG. 2, a resistance-welding type storage rack layer plate is provided, including a first taper sleeve 1, a second taper sleeve 2, a third taper sleeve 3, a fourth taper sleeve 4, a first frame assembly 5, a second frame assembly 6, a third frame assembly 7 and a fourth frame assembly 8; the first frame assembly 5, the second frame assembly 6, the third frame assembly 7 and the fourth frame assembly 8 comprise a first metal connecting rod 9 and a second metal connecting rod 10; the two ends of the first metal connecting rod 9 and the second metal connecting rod 10 are respectively provided with a fitting and welding part 11, adjacent ends of the first frame assembly 5 and the second frame assembly 6 fit with the outer wall of the first taper sleeve 1 through the fitting and welding part 11 and the fitting and welding part 11 is integrally connected with the first taper sleeve 1 by resistance welding, adjacent ends of the second frame assembly 6 and the third frame assembly 7 fit with the outer wall of the second taper sleeve 2 through the fitting and welding part 11 and the fitting and welding part 11 is integrally connected with the second taper sleeve 2 by resistance welding, adjacent ends of the third frame assembly 7 and the fourth frame assembly 8 fit with the outer wall of the third taper sleeve 3 through the fitting and welding part 11 and the fitting and welding part 11 is integrally connected with the third taper sleeve 3 by resistance welding, adjacent ends of the first frame assembly 5 and the fourth frame assembly 8 fit with the outer wall of the fourth taper sleeve 4 through the fitting and welding part 11 and the fitting and welding part 11 is integrally connected with the fourth taper sleeve 4 by resistance welding; the resistance-welding type storage rack layer plate further includes a storage plate 12 integrally connected with the first frame assembly 5, the second frame assembly 6, the third frame assembly 7 and the fourth frame assembly 8.

As a preferred embodiment, in this embodiment, the first frame assembly 5, the second frame assembly 6, the third frame assembly 7 and the fourth frame assembly 8 further include a wavy reinforcing rib 13 connected with the first metal connecting rod 9 and the second metal connecting rod 10 to enhance the strength of the frame assembly.

As a preferred embodiment, in this embodiment, the fitting and welding part 11 is bended inwards, and the inner side surface of the fitting and welding part 11 fits with and, by resistance welding, is integrally connected with the outer walls of the first taper sleeve 1, the second taper sleeve 2, the third taper sleeve 3 and the fourth taper sleeve 4.

As a preferred embodiment, in this embodiment, the first taper sleeve 1, the second taper sleeve 2, the third taper sleeve 3 and the fourth taper sleeve 4 are in a hollow truncated cone shape, and the first taper sleeve 1, the second taper sleeve 2, the third taper sleeve 3 and the fourth taper sleeve 4 have a taper of 5 to 20 degrees, so as to realize the assembly location between the storage rack layer plate and a storage rack.

As a preferred embodiment, in this embodiment, the storage plate 12 is a net plate, which may save material.

To sum up, the resistance-welding type storage rack layer plate is welded without using welding wires or carbon dioxide, is convenient to weld and low in welding cost and is beneficial for environment protection.

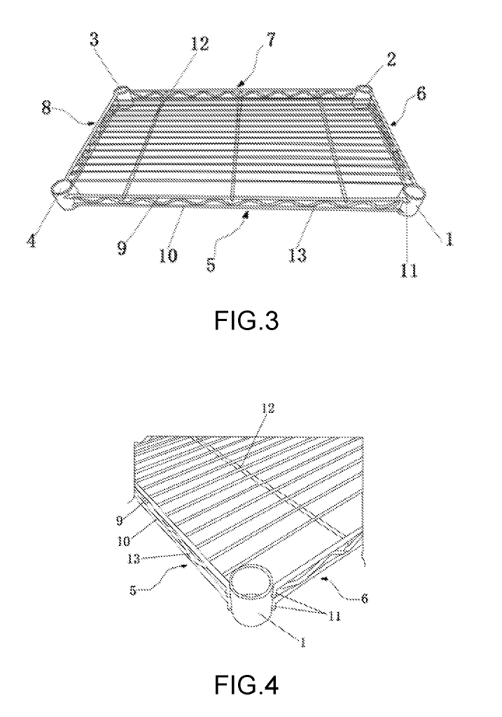

Embodiment 2, please refer to FIG. 3 and FIG. 4, a resistance-welding type storage rack layer plate is provided, in this embodiment, the fitting and welding part 11 is bended inwards, and the inner side surface of the fitting and welding part 11 fits with and, by resistance welding, is integrally connected with the outer walls of the first taper sleeve 1, the second taper sleeve 2, the third taper sleeve 3 and the fourth taper sleeve 4. Other structures are the same as those in Embodiment 1, and no further description is needed here.

Of course, the fitting and welding part 11 also may be arranged vertically or obliquely upwards or downwards along the axial direction of the first taper sleeve 1, the second taper sleeve 2, the third taper sleeve 3 or the fourth taper sleeve 4; and the fitting and welding part 11 is integrally connected with a corresponding taper sleeve by resistance welding.

The above embodiments are preferred implementations of the disclosure merely, however, the implementation of the disclosure is not limited to the above embodiments; any other variations, modifications, substitutions, combinations and simplifications made without departing from the spiritual essence and principle of the disclosure are equivalent replacement methods and are intended to be included in the scope of protection of the disclosure.

What is claimed is:

1. A resistance-welding type storage rack layer plate, characterized in that: the resistance-welding type storage rack layer plate comprises a first taper sleeve (1), a second taper sleeve (2), a third taper sleeve (3), a fourth taper sleeve (4), a first frame assembly (5), a second frame assembly (6), a third frame assembly (7) and a fourth frame assembly (8); the first frame assembly (5), the second frame assembly (6), the third frame assembly (7) and the fourth frame assembly (8) comprise a first metal connecting rod (9) and a second metal connecting rod (10); the two ends of the first metal connecting rod (9) and the second metal connecting rod (10) are respectively provided with a fitting and welding part (11), adjacent ends of the first frame assembly (5) and the second frame assembly (6) fit with the outer wall of the first taper sleeve (1) through the fitting and welding part (11) and the fitting and welding part (11) is integrally connected with the first taper sleeve (1) by resistance welding, adjacent ends of the second frame assembly (6) and the third frame assembly (7) fit with the outer wall of the second taper sleeve (2) through the fitting and welding part (11) and the fitting and welding part (11) is integrally connected with the second taper sleeve (2) by resistance welding, adjacent ends of the third frame assembly (7) and the fourth frame assembly (8) fit with the outer wall of the third taper sleeve (3) through the fitting and welding part (11) and the fitting and welding part (11) is integrally connected with the third taper sleeve (3) by resistance welding, adjacent ends of the first frame assembly (5) and the fourth frame assembly (8) fit with the outer wall of the fourth taper sleeve (4) through the fitting and welding part (11) and the fitting and welding part (11) is integrally connected with the fourth taper sleeve (4) by resistance welding; the resistance-welding type storage rack layer plate further comprises a storage plate (12) integrally connected with the first frame assembly (5), the second frame assembly (6), the third frame assembly (7) and the fourth frame assembly (8).

2. The resistance-welding type storage rack layer plate according to claim 1, characterized in that: the first frame assembly (5), the second frame assembly (6), the third frame assembly (7) and the fourth frame assembly (8) further comprise a wavy reinforcing rib (13) connected with the first metal connecting rod (9) and the second metal connecting rod (10).

3. The resistance-welding type storage rack layer plate according to claim 1, characterized in that: the fitting and welding part (11) is bended inwards, and the inner side surface of the fitting and welding part (11) fits with and, by resistance welding, is integrally connected with the outer walls of the first taper sleeve (1), the second taper sleeve (2), the third taper sleeve (3) and the fourth taper sleeve (4).

4. The resistance-welding type storage rack layer plate according to claim 1, characterized in that: the fitting and welding part (11) is bended outwards, and the inner side surface of the fitting and welding part (11) fits with and, by resistance welding, is integrally connected with the outer walls of the first taper sleeve (1), the second taper sleeve (2), the third taper sleeve (3) and the fourth taper sleeve (4).

5. The resistance-welding type storage rack layer plate according to claim 1, characterized in that: the first taper sleeve (1), the second taper sleeve (2), the third taper sleeve (3) and the fourth taper sleeve (4) are in a hollow truncated cone shape.

6. The resistance-welding type storage rack layer plate according to claim 5, characterized in that: the first taper sleeve (1), the second taper sleeve (2), the third taper sleeve (3) and the fourth taper sleeve (4) have a taper of 5 to 20 degrees.

7. The resistance-welding type storage rack layer plate according to claim 1, characterized in that: the storage plate (12) is a net plate.
